(19) United States
(12) Patent Application Publication
(10) Pub. No.: US 2020/0037107 A1
(43) Pub. Date: Jan. 30, 2020

(54) INFORMATION PROCESSING DEVICE, TERMINAL DEVICE, INFORMATION PROCESSING METHOD, AND STORAGE MEDIUM HAVING PROGRAM STORED THEREIN

(71) Applicant: NEC Corporation, Tokyo (JP)

(72) Inventor: Ryo KUSUMOTO, Tokyo (JP)

(73) Assignee: NEC Corporation, Tokyo (JP)

(21) Appl. No.: 16/491,422

(22) PCT Filed: Mar. 6, 2018
(86) PCT No.: PCT/JP2018/008449

§ 371 Date: Sep. 5, 2019

(30) Foreign Application Priority Data
Mar. 9, 2017 (JP) 2017-044505

(51) Int. Cl. H04W 4/02; H04W 4/029; H04M 1/725; H04W 4/021

(52) U.S. Cl. CPC H04W 4/025; H04W 4/021; H04M 1/72519; H04W 4/029

(57) ABSTRACT

In order to improve user convenience, an information processing device is provided with a prediction quality acquisition unit which, on the basis of route information from a departure place to an arrival place, acquires predicted communication quality of a wireless communication device at least at the arrival place.

### TECHNICAL FIELD

The present invention relates to an information processing device, a terminal device, an information processing method, and a program.

### BACKGROUND ART

In recent years, widespread use of smartphones and the like has increased opportunities to download and upload a large-capacity data file such as a video and an image. Even when a user uses a flat-rate communication service, there is an upper limit in communication capacity and thus the user often desires to communicate by using a wireless access point and the like. A technique described in PTL 1 is, for example, a technique of presenting, to a user, a communication speed of a wireless access point around a current location and a communicable place around the current location. Further, a technique described in PTL 2 is, for example, a technique of displaying, on a map, a road where communication can be performed and a road where communication cannot be performed.

### CITATION LIST

### Patent Literature

[PTL 1] Japanese Unexamined Patent Application Publication No. 2016-76840
[PTL 2] Japanese Unexamined Patent Application Publication No. 2004-96267

### SUMMARY OF INVENTION

### Technical Problem

When a user moves, only presence or absence of a wireless access point around a current location and communication quality such as a communication speed around the current location can be grasped even by using the techniques described in PTLs 1 and 2, and presence or absence of a wireless access point and communication quality at a destination cannot be found until the user actually reaches the destination, and therefore there is a problem that user convenience is not sufficient.

An object of the present invention is to provide an information processing device, a terminal device, an information processing method, and a program that solve the above-described problem.

### Solution to Problem

An information processing device, according to a first aspect of the present invention, includes a prediction quality acquisition unit for acquiring, based on route information from a departure place to a destination, predicted communication quality of a radio communication device at least at the destination.

A terminal device, according to a second aspect of the present invention, includes a display unit for displaying route information from a departure place to a destination and predicted communication quality of a radio communication device at least at the destination.

An information processing method, according to a third aspect of the present invention, includes, based on route information from a departure place to a destination, acquiring predicted communication quality of a radio communication device at least at the destination.

An information processing method, according to a fourth aspect of the present invention, includes displaying route information from a departure place to a destination and predicted communication quality of a radio communication device at least at the destination.

A program, according to a fifth aspect of the present invention, causes a computer in an information processing device to execute processing of acquiring predicted communication quality of a radio communication device at least at a destination, based on route information from a departure place to the destination.

A program, according to a sixth aspect of the present invention, causes a computer in a terminal device to execute processing of displaying route information from a departure place to a destination and predicted communication quality of a radio communication device at least at the destination.

### Advantageous Effects of Invention

One aspect of the present invention is able to enhance user convenience.

### BRIEF DESCRIPTION OF DRAWINGS

FIG. 1 is a system configuration diagram illustrating one example of a configuration of an information processing system according to a first example embodiment.

FIG. 2 is a schematic block diagram illustrating one example of a hardware configuration of a terminal device according to the first example embodiment.

FIG. 3 is a schematic block diagram illustrating one example of a software configuration of the terminal device according to the first example embodiment.

FIG. 4 is a schematic block diagram illustrating another example of the software configuration of the terminal device according to the first example embodiment.

FIG. 5 is a schematic block diagram illustrating one example of a hardware configuration of a route search device according to the first example embodiment.

FIG. 6 is a schematic block diagram illustrating one example of a software configuration of the route search device according to the first example embodiment.

FIG. 7 is a schematic block diagram illustrating another example of the software configuration of the route search device according to the first example embodiment.

FIG. 8 is a flowchart illustrating one example of information processing by the terminal device according to the first example embodiment.

FIG. 9 is a flowchart illustrating one example of information processing by the route search device according to the first example embodiment.

### EXAMPLE EMBODIMENT

In the following, example embodiments of the present invention will be described with reference to the drawings.

### First Example Embodiment

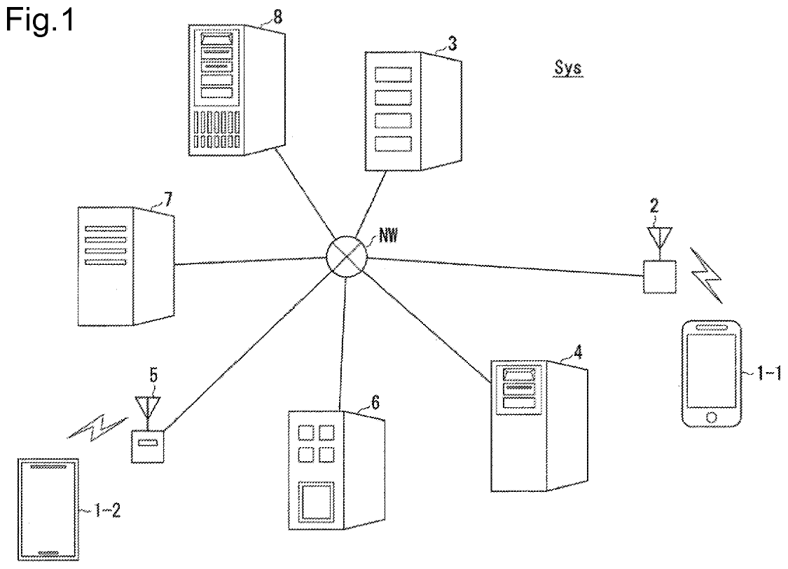

FIG. 1 is a system configuration diagram illustrating one example of a configuration of an information processing system Sys according to a first example embodiment.

The information processing system Sys is configured to include a terminal device 1-1, a terminal device 1-2, a first wireless access point 2, a measurement device 3, a measurement result storage device 4, a second wireless access point 5, a route search device 6, a management device 7 and a prediction device 8.

The terminal device 1-1 performs communication via the first wireless access point 2. The terminal device 1-2 performs communication via the second wireless access point 5. Herein, the first wireless access point 2 and the second wireless access point 5 may be base station devices, wireless access points, or communication devices capable of communicating with a terminal device and a network. Further, the first wireless access point 2 and the second wireless access point 5 are described as different wireless access points for convenience of description, however, they may be same wireless access points or may be different wireless access points. Further, the terminal device 1-1 and the terminal device 1-2 are referred to as a terminal device 1, when the terminal device 1-1 and the terminal device 1-2 are not specifically distinguished.

The first wireless access point 2, the measurement device 3, the measurement result storage device 4, the second wireless access point 5, the route search device 6, the management device 7, and the prediction device 8 can communicate with one another via a network NW.

The terminal device 1 is, for example, an electronic device capable of wireless communication such as a smartphone and a tablet terminal. The terminal device 1 displays a communication speed (throughput) between the terminal device 1 and a predetermined server device as communication quality (network quality), the communication speed (throughput) being measured according to a user operation.

The first wireless access point 2 and the second wireless access point 5 are, for example, wireless access points such as Wi-Fi (registered trademark).

The measurement device 3 measures a communication speed (throughput) between the terminal device 1-1 and the predetermined server device as communication quality (network quality) via the first wireless access point 2. Specifically, the measurement device 3 measures each of throughputs relating to uplink communication and relating to downlink communication between the terminal device 1-1 and the predetermined server device, and transmits the measurement results to the terminal device 1-1.

The measurement result storage device 4 associates the measurement results of communication quality transmitted from the terminal device 1-1, date information thereof, and location information on the terminal device 1-1 when performing the measurement, with one another, and stores the associated result therein.

Note that, in the following description, it is assumed that the measurement result storage device 4 stores a plurality of associated results by associating throughputs relating to uplink communication and downlink communication between a plurality of terminal devices such as the terminal device 1-1 and a predetermined server device with date information.

The terminal device 1-2 transmits, to the route search device 6 via the second wireless access point 5, search information including: at least a departure place; a destination, time information including a departure time or an arrival time; and data amount information representing a desired amount of data, the search information being for searching a route and being given by a user. Further, the terminal device 1-2 receives, from the route search device 6, search result information such as route information from the departure place to the destination, a time required to upload or download the desired data amount, predicted communication quality and presence or absence of a wireless access point at the destination and the like. The terminal device 1-2 provides the user with a search result, based on the received search result information.

The route search device 6 (also referred to as an information processing device) searches a route from the departure place to the destination and an estimated arrival time, based on the search information received from the terminal device 1-2. Further, the route search device 6 extracts and acquires, from the management device 7, information on presence or absence of a wireless access point at the destination, based on the search information. Further, the route search device 6 requires the prediction device 8 for a prediction result of communication quality at the destination, based on the destination included in the search information and the estimated arrival time at the destination included in the search result. Then, the route search device 6 acquires, from the prediction device 8, the predicted result of communication quality at the estimated arrival time at the destination. The route search device 6 transmits, to the terminal device 1-2, search result information such as route information from the departure place to the destination, a time required to upload or download the desired data amount, the predicted communication quality, and presence or absence of a wireless access point at the destination and the like, as a search result.

The management device 7 manages location information on a wireless access point at public facilities and the like such as a station and an airport, and provides the location information on the wireless access point in response to a request.

The prediction device 8 predicts predicted communication quality at the estimated arrival time at the destination, based on the search information and the search result information from the route search device 6. Specifically, the prediction device 8 extracts and acquires a measurement result of communication quality at the estimated arrival time from the measurement result storage device 4 that stores a measurement result of communication quality at the destination measured in the past, as predicted communication quality at the destination. The prediction device 8 transmits, to the route search device 6, the acquired predicted communication quality.

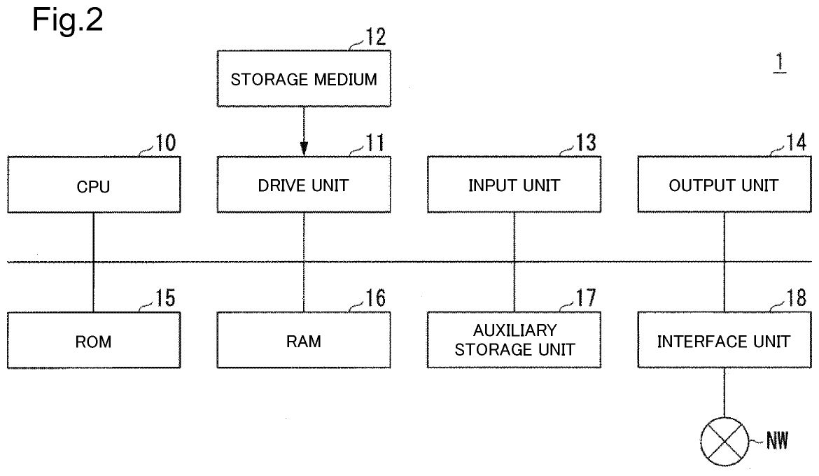

FIG. 2 is a schematic block diagram illustrating one example of a hardware configuration of the terminal device 1 according to the first example embodiment.

The terminal device 1 includes a CPU 10, a drive unit 11, a storage medium 12, an input unit 13, an output unit 14, a read only memory (ROM) 15, a random access memory (RAM) 16, an auxiliary storage unit 17, and an interface unit 18. The CPU 10, the drive unit 11, the input unit 13, the output unit 14, the ROM 15, the RAM 16, the auxiliary storage unit 17, and the interface unit 18 are connected to one another via a bus.

The CPU 10 reads and executes a program stored in the auxiliary storage unit 17 and various data stored in the ROM 15 and the RAM 16, and controls the terminal device 1. Further, the CPU 10 reads and executes various data stored in the storage medium 12 via the drive unit 11, and controls the terminal device 1. The storage medium 12 is a portable storage medium such as a magneto-optical disk, a flexible disk, and a flash memory, and stores various data. The drive unit 11 is a readout device for the storage medium 12 such as an optical disk drive and a flexible disk drive. The input unit 13 is an input device such as a mouse, a keyboard, and a touch panel. The output unit 14 is an output device such as a display unit and a speaker. The ROM 15 and the RAM 16 store various data. The auxiliary storage unit 17 is a hard disk drive, a flash memory, or the like, and stores a program for causing each functional unit in the terminal device 1 to operate and various data. The interface unit 18 includes a communication interface and is connected to the network NW by wired or wireless line.

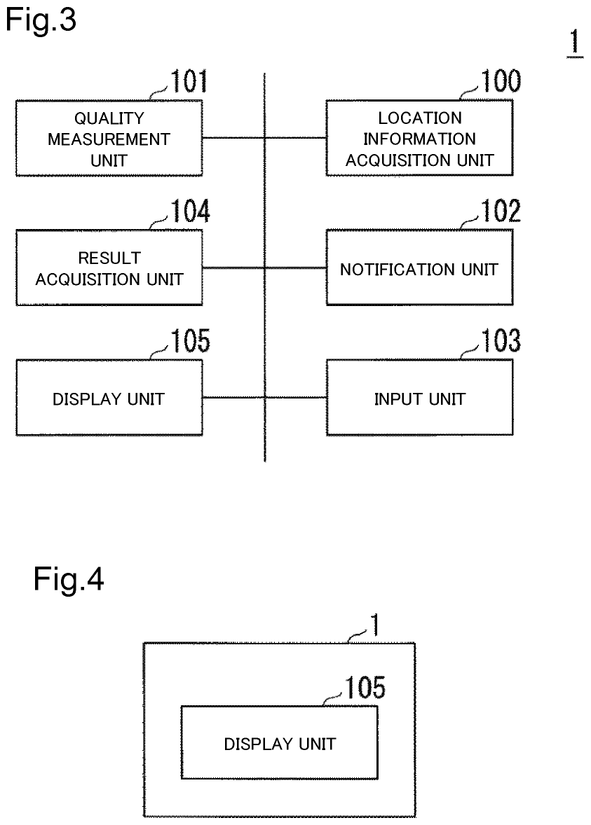

For example, a location information acquisition unit 100 and an input unit 103 in a software configuration of the terminal device 1 in FIG. 3 described later associate with the input unit 13 in FIG. 2, a notification unit 102 in FIG. 3 associates with the interface unit 18 in FIG. 2, a quality measurement unit 101 and a result acquisition unit 104 in FIG. 3 associate with the CPU 10 in FIG. 2, and a display unit 105 in FIG. 3 associates with the output unit 14 in FIG. 2.

FIG. 3 is a schematic block diagram illustrating one example of the software configuration of the terminal device 1 according to the first example embodiment.

The terminal device 1 is configured to include the location information acquisition unit 100, the quality measurement unit 101, the notification unit 102, the input unit 103, the result acquisition unit 104, and the display unit 105.

### <Measurement of Communication Quality>

First, measurement of communication quality is described.

The location information acquisition unit 100 acquires location information of the terminal device 1 constituted by a latitude and a longitude, from a global positioning system (GPS), for example.

The quality measurement unit 101, for example, communicates with the measurement device 3 and transmits/receives a packet for measuring throughput of uplink and throughput of downlink as communication quality between the terminal device 1 and a predetermined server device.

When receiving a measurement result from the measurement device 3, the notification unit 102 associates the measurement result, the location information acquired by the location information acquisition unit 100, and date information with one another, and notifies the measurement result storage device 4 of the associated result to be stored therein.

Note that communication quality may be measured by installing in advance a dedicated application for measurement of communication quality in the terminal device 1 and causing the quality measurement unit 101 in the terminal device 1 to communicate with the measurement device 3. In this case, the quality measurement unit 101 may store, in the measurement result storage device 4, the location information acquired by the location information acquisition unit 100 and the measurement result of communication quality measured by using the application via the application.

In this manner, the communication quality measured by the terminal device 1 and the measurement device 3 is cumulatively stored in the measurement result storage device 4.

### <Prediction of Communication Quality at a Destination>

Next, prediction of communication quality at a destination is described.

The input unit 103 receives, as search information, input of a departure place, a destination, a departure time or an arrival time, and a desired data amount from a user. Herein, the location information acquired by the location information acquisition unit 100 may be used for a departure place, and a destination, an arrival time at the destination, and a desired data amount may be received as search information.

The result acquisition unit 104 transmits, to the route search device 6, the search information for prediction of communication quality at the destination received by the input unit 103. Then, the result acquisition unit 104 receives search result information from the route search device 6, thereby acquiring a search result representing predicted communication quality at the destination.

The display unit 105 displays the search result acquired by the result acquisition unit 104.

Note that the input unit 103 may receive input of a via point other than a departure place and a destination. In this case, the via point is regarded as a first destination and the destination is regarded as a second destination and each of predicted communication qualities at the first destination and the second destination may be acquired.

FIG. 4 is a schematic block diagram illustrating another example of the software configuration of the terminal device 1 according to the first example embodiment.

As illustrated, the terminal device 1 may include at least the display unit 105.

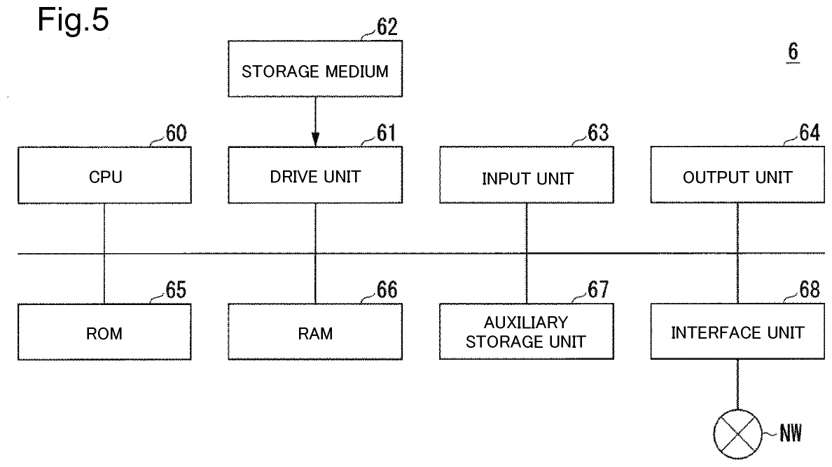

FIG. 5 is a schematic block diagram illustrating one example of a hardware configuration of the route search device 6 according to the first example embodiment.

The route search device 6 includes a CPU 60, a drive unit 61, a storage medium 62, an input unit 63, an output unit 64, a read only memory (ROM) 65, a random access memory (RAM) 66, an auxiliary storage unit 67, and an interface unit 68. The CPU 60, the drive unit 61, the input unit 63, the output unit 64, the ROM 65, the RAM 66, the auxiliary storage unit 67, and the interface unit 68 are connected to one another via a bus.

The CPU 60 reads and executes a program stored in the auxiliary storage unit 67 and various data stored in the ROM 65 and the RAM 66, and controls the route search device 6. Further, the CPU 60 reads and executes various data stored in the storage medium 62 via the drive unit 61, and controls the route search device 6. The storage medium 62 is a portable storage medium such as a magneto-optical disk, a flexible disk, and a flash memory, and stores various data. The drive unit 61 is a readout device for the storage medium 62 such as an optical disk drive and a flexible disk drive. The input unit 63 is an input device such as a mouse, a keyboard, and a touch panel. The output unit 14 is an output device such as a display unit and a speaker. The ROM 65 and the RAM 66 store various data. The auxiliary storage unit 67 is a hard disk drive, a flash memory, and the like and stores a program for causing each functional unit in the route search device 6 to operate and various data. The interface unit 68 includes a communication interface and is connected to the network NW by a wired or wireless line.

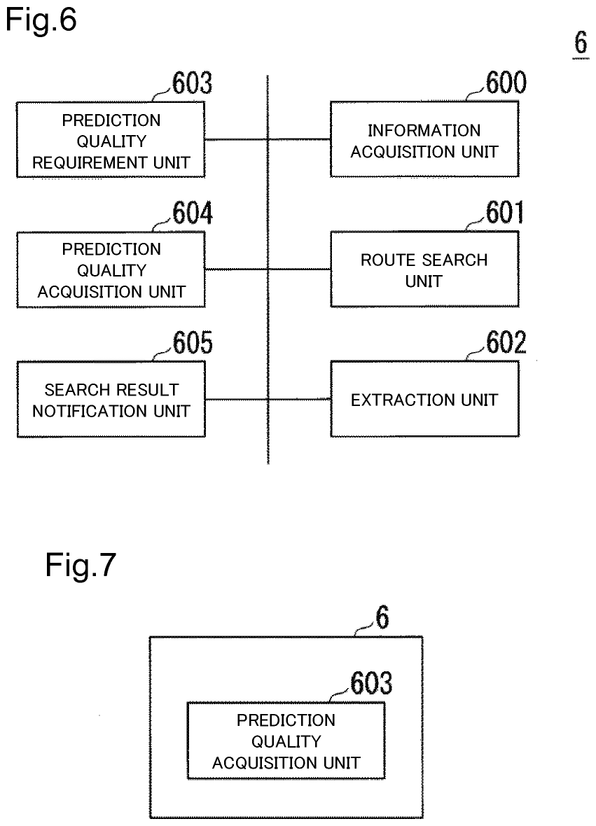

For example, an information acquisition unit 600, a route search unit 601, an extraction unit 602, a prediction quality requirement unit 603, a prediction quality acquisition unit 604, and a search result notification unit 605 in a software configuration of the route search device 6 in FIG. 6 described later associate with the CPU 60 and communicate with a terminal device and other devices via the interface unit 68.

FIG. 6 is a schematic block diagram illustrating one example of the software configuration of the route search device 6 according to the first example embodiment.

The route search device 6 is configured to include the information acquisition unit 600, the route search unit 601, the extraction unit 602, the prediction quality requirement unit 603, the prediction quality acquisition unit 604, and the search result notification unit 605.

The information acquisition unit 600 acquires, from the terminal device 1, search information including a departure place, a destination, a departure time or an arrival time, and a desired data amount.

The route search unit 601 executes route search from the departure place to the destination included in the search information acquired from the terminal device 1, and generates route information (search result information) including a route from the departure place to the destination and an estimated arrival time at the destination.

The extraction unit 602 extracts, from the management device 7, location information on a wireless access point at the destination included in the route information generated by the route search unit 601 or the search information acquired by the information acquisition unit 600.

The prediction quality requirement unit 603 requires prediction of communication quality at the estimated arrival time at the destination, based on the route information generated by the route search unit 601.

The prediction quality acquisition unit 604 acquires predicted communication quality as a prediction result in response to the requirement of the prediction of communication quality by the prediction quality requirement unit 603. Specifically, the prediction device 8 acquires, in response to the requirement for acquiring the predicted communication quality, communication quality measured at the destination in the past, stored in the measurement result storage device 4 and associated with a period of time, a day of week, and the like including the estimated arrival time. And then, the prediction device 8 performs analysis such as a calculation of a mean value, a calculation of a median value, and the like with respect to the acquired communication quality measured at the destination in the past and associated with the period of time, the day of week, and the like including the estimated arrival time. Then, the prediction quality acquisition unit 604 acquires, as a predicted communication quality, a result of the analysis performed by the prediction device 8.

The search result notification unit 605 notifies the terminal device 1 of the predicted communication quality acquired by the prediction quality acquisition unit 604 as search result information. The search result information includes the route information from the departure place to the destination, a time required to upload or download the desired data amount, the predicted communication quality, and the information on presence or absence of a wireless access point at the destination and the like.

Note that the information acquisition unit 600 may also receive information on a via point other than a departure place and a destination. In this case, the via point is regarded as a first destination and the destination is regarded as a second destination, and each of predicted communication qualities at the first destination and the second destination may be acquired from the prediction device 8. Further, when a route search result from a departure place to a destination by the route search unit 601 includes, for example, a transfer place or a resting place, the transfer place or the resting place is regarded as a first destination, a final destination is regarded as a second destination, or the like, and a wireless access point may be extracted and predicted communication quality may be acquired.

FIG. 7 is a schematic block diagram illustrating another example of the software configuration of the route search device 6 according to the first example embodiment.

As illustrated, the route search device 6 may include at least the prediction quality acquisition unit 604.

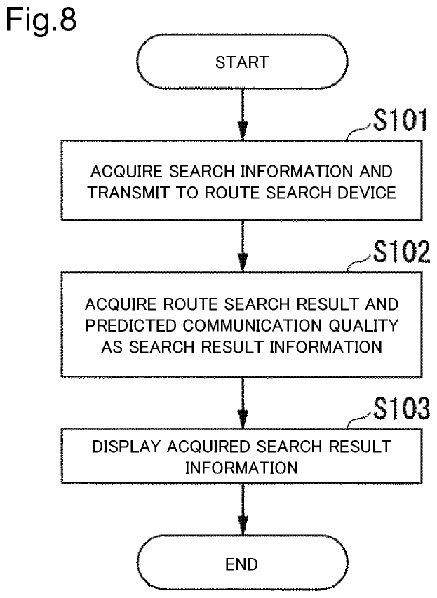

FIG. 8 is a flowchart illustrating one example of information processing by the terminal device 1 according to the first example embodiment.

In step S101, the terminal device 1 acquires search information by receiving the search information from a user by the input unit 103, and transmits the search information to the route search device 6.

In step S102, the terminal device 1 acquires, from the route search device 6, search result information including a route search result and a predicted communication quality in response to the transmission of the search information.

In step S103, the terminal device 1 displays and provides the acquired search result information for the user.

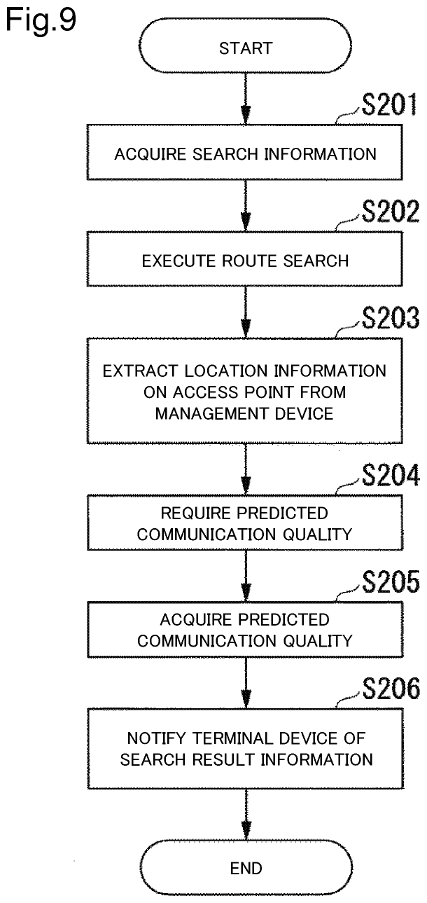

FIG. 9 is a flowchart illustrating one example of information processing by the route search device 6 according to the first example embodiment.

In step S201, the route search device 6 acquires search information from the terminal device 1.

In step S202, the route search device 6 executes route search, based on the search information, and generates route information.

In step S203, the route search device 6 extracts, from the management device 7, location information on a wireless access point at a destination, based on the route information.

In step S204, the route search device 6 requires the prediction device 8 for prediction of communication quality at an estimated arrival time at the destination, based on the route information.

In step S205, the route search device 6 acquires, from the prediction device 8, the predicted communication quality at the estimated arrival time at the destination in response to the request.

In step S206, the route search device 6 notifies the terminal device 1 of search result information including the route information from a departure place to the destination, a time required to upload or download a desired data amount, the predicted communication quality, and information on presence or absence of a wireless access point at the destination and the like, based on the acquired predicted communication quality.

In this manner, according to the first example embodiment, the route search device 6 (information processing device) includes: the information acquisition unit 600 that acquires search information including a departure place, a destination, any one of time information relating to a departure time at the departure place and time information relating to an arrival time at the destination, and data size; the search unit (route search unit 601) that acquires route information by searching a route from the departure place to the destination, based on the search information; the prediction quality acquisition unit 604 that acquires predicted communication quality of a radio communication device (wireless access point) at least at the destination, based on the route information; and the notification unit (search result notification unit 605) that notifies a search result and the predicted communication quality.

Such a configuration enables prediction of communication quality based on a past measured value at an arrival time prior to arrival at a destination and therefore user convenience can be enhanced. Further, the predicted communication quality enables a user to grasp time required for communication of a desired data amount and therefore user convenience can be enhanced.

Note that the present example embodiment may be reconfigured by combining a plurality of devices among the measurement device 3, the measurement result storage device 4, the route search device 6, the management device 7, and the prediction device 8 as one device or a plurality of devices, or may be implemented by executing a part of functions of any device among the measurement device 3, the measurement result storage device 4, the route search device 6, the management device 7, and the prediction device 8 by another device.

Note that a first wireless access point and a second wireless access point are not limited to wireless access points using Wi-Fi (registered trademark) and, for example, the present example embodiment may be applied for the purpose of predicting communication quality of a mobile phone network. Such an application enables a user to grasp, from a moving route, a spot suitable for transmitting/receiving a file in shorter time, even when communication speed varies in each area, and therefore user convenience can be enhanced.

Note that a program operated in the terminal device 1 and the route search device 6 in one aspect of the present invention may be a program that controls a central processing unit (CPU) or the like (a program causing a computer to function) in such a way as to implement the functions indicated in the above-described example embodiments and modification examples relating to one aspect of the present invention. Then, pieces of information to be handled in the devices are temporarily accumulated in a random access memory (RAM) during processing thereof, then are stored in various ROMs, such as a flash read only memory (ROM), and a hard disk drive (HDD), and are read by a CPU for correction/writing as necessary.

Note that the terminal device 1 and a part of the route search device 6 in the above-described example embodiments and modification examples may be implemented by a computer. In this case, the terminal device 1 and a part of the route search device 6 in the above-described example embodiments and modification examples may be implemented by recording a program for implementing this control function in a computer-readable recording medium, and causing a computer system to read and execute the program recorded in the recording medium.

Note that the “computer system” here is a computer system incorporated in the terminal device 1 and the route search device 6, and includes a hardware such as an OS and peripherals. Further, the “computer-readable recording medium” is a storage device such as a portable medium including a flexible disk, a magneto-optical disk, a ROM, a CD-ROM, and the like and a hard disk incorporated in the computer system.

Further, the “computer-readable recording medium” may include a recording medium that dynamically holds a program for a short time like a communication line when a program is transmitted via a network such as the Internet or a communication line such as a telephone line, and may also include a recording medium that holds a program for a certain period like a server or a volatile memory inside a computer system being a client in such a case. Further, the above-described programs may be also a program for implementing a part of the aforementioned functions and, furthermore, may be also a program capable of implementing by a combination with a program already recording the aforementioned functions in a computer system.

Further, the terminal device 1, a part or all of the route search device 6 in each of the above-described example embodiments and modification examples may be implemented as LSI being typically an integrated circuit or as a chip set. Further, each functional block of the terminal device 1 and the route search device 6 in each of the above-described example embodiments and modification examples may be formed into chip individually or may be formed into chip by integrating a part or all. Further, a method of making an integrated circuit is not limited to LSI and may be achieved by a dedicated circuit and/or a general-purpose processor. Further, when a technique of making an integrated circuit replacing LSI emerges due to advance in semiconductor technology, it is possible to use an integrated circuit by the technique.

Further, in each of the above-described example embodiments and modification examples, the terminal device is described as one example of a communication device. However, one aspect of the invention of the present application is not limited to this, and is also applicable to a terminal device such as stationary type and/or non-movable type electronic equipment installed indoor or outdoor including, for example, audiovisual equipment, kitchen appliances, cleaning equipment/a washing machine, an air conditioner, office equipment, a vending machine, an automobile, a bicycle, and other home appliances, or a communication device.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2017-044505, filed on Mar. 9, 2017, the disclosure of which is incorporated herein in its entirety by reference.

### REFERENCE SIGNS LIST

Sys Information processing system
1, 1-1, 1-2 Terminal device
10 CPU
11 Drive unit
12 Storage medium
13 Input unit
14 Output unit
15 ROM
16 RAM
17 Auxiliary storage unit
18 Interface unit
100 Location information acquisition unit
101 Quality measurement unit
102 Notification unit
103 Input unit
104 Result acquisition unit
105 Display unit
2 First wireless access point
3 Measurement device
4 Measurement result storage device
5 Second wireless access point
6 Route search device
60 CPU
61 Drive unit
62 Storage medium
63 Input unit
64 Output unit
65 ROM
66 RAM
67 Auxiliary storage unit
68 Interface unit
600 Information acquisition unit
601 Route search unit
602 Extraction unit
603 Prediction quality requirement unit
604 Prediction quality acquisition unit
605 Search result notification unit
7 Management device
8 Prediction device

1. An information processing device, comprising
a prediction quality acquisition unit configured to acquire, based on route information from a departure place to a destination, predicted communication quality of a radio communication device at least at the destination.

2. The information processing device according to claim 1, further comprising:
an information acquisition unit configured to acquire search information including the departure place, the destination, any one of time information relating to a departure time at the departure place and time information relating to an arrival time at the destination, and a data size;
a search unit configured to acquire route information by searching for a route from the departure place to the destination, based on the search information; and
a notification unit configured to notify the route information and the predicted communication quality.

3. The information processing device according to claim 1, wherein
the prediction quality acquisition unit acquires the predicted communication quality predicted based on communication quality measured at each place in advance.

4. The information processing device according to claim 1, wherein
the prediction quality acquisition unit acquires, when the route information has a via point, predicted communication quality of the radio communication device at the via point.

5. The information processing device according to claim 1, wherein
the prediction quality acquisition unit acquires location information of the radio communication device at least at the destination, based on the route information, and acquires the predicted communication quality of the radio communication device.

6. A terminal device, comprising
a display unit configured to display route information from a departure place to a destination and predicted communication quality of a radio communication device at least at the destination.

7. An information processing method, comprising
based on route information from a departure place to a destination, acquiring predicted communication quality of a radio communication device at least at the destination.

8. (canceled)

9. (canceled)

10. (canceled)
